(19) United States
(12) Patent Application Publication
(10) Pub. No.: US 2020/0117585 A1
(43) Pub. Date: Apr. 16, 2020

(54) METHOD AND APPARATUS FOR COMPUTER-AIDED TESTING OF A BLOCKCHAIN

(71) Applicant: SIEMENS AKTIENGESELLSCHAFT, MÜNCHEN (DE)

(72) Inventor: RAINER FALK, POING (DE)

(21) Appl. No.: 16/604,176

(22) PCT Filed: Mar. 29, 2018
(86) PCT No.: PCT/EP2018/058148

§ 371 Date: Oct. 10, 2019

(30) Foreign Application Priority Data
Apr. 12, 2017 (EP) 17166334.7

(51) Int. Cl. G06F 11/36; H04L 9/06; G06Q 20/22

(52) U.S. Cl. CPC G06F 11/3688; H04L 9/0637; H04L 2209/56; G06Q 20/223; H04L 2209/38; H04L 9/0643

(57) ABSTRACT

Provided is a method for testing a blockchain in a computer-aided manner, having the following method steps: generating a specified transaction and/or a specified smart contract, the specified transaction and/or the specified smart contract being paired with a respective specification value; adding the specified transaction and/or the specified smart contract into the blockchain; carrying out the specified transaction and/or the specified smart contract, a measurement value of the specified transaction and/or the specified smart contract being detected; and testing the measurement value using the specification value, wherein a control signal is provided in the event of a deviation from the specification value.

### CROSS-REFERENCE TO RELATED APPLICATIONS

This application claims priority to PCT Application No. PCT/EP2018/058148, having a filing date of Mar. 29, 2018, which is based on European Application No. 17166334.7, having a filing date of Apr. 12, 2017, the entire contents both of which are hereby incorporated by reference.

### FIELD OF TECHNOLOGY

The following relates to a method and an apparatus for computer-aided testing of a blockchain.

### BACKGROUND

The technology of blockchains or “distributed ledgers” is currently a hotly debated technology. Besides applications for decentralized payment systems (e.g. Bitcoin), new application options are being developed in the finance industry. In particular, transactions between firms can thus be realized in manipulation-proof fashion without a mediator or clearing house. This allows new business models without a trusted mediator, it reduces transaction costs, and new digital services can be provided flexibly without having to set up an infrastructure configured specifically therefor and trust relationships. A transaction data record (or transaction, for short) protected by a blockchain comprises for example a program code, which can also be referred to as a “smart contract”.

### SUMMARY

An aspect relates to a method and an apparatus for computer-aided testing of a blockchain.

According to a first aspect, an embodiment relates to a method for computer-aided testing of a blockchain, having the following method steps:
generating a prescribed transaction and/or a prescribed smart contract, wherein the prescribed transaction and/or the prescribed smart contract each have an associated preset value;
inserting the prescribed transaction and/or the prescribed smart contract into the blockchain;
performing the prescribed transaction and/or the prescribed smart contract, wherein a measured value for the performance of the prescribed transaction and/or the prescribed smart contract is recorded;
testing the measured value on the basis of the preset value, wherein a deviation from the preset value results in a control signal being provided.

Unless indicated otherwise in the description below, the terms “perform”, “calculate”, “computer-aided”, “compute”, “find”, “generate”, “configure”, “reconstruct” and the like relate to actions and/or processes and/or processing steps that alter and/or generate data and/or that convert data into other data, the data being able to be presented or available as physical variables, in particular, for example as electrical impulses. In particular, the expression “computer” should be interpreted as broadly as possible in order to cover in particular all electronic devices having data processing properties. Computers can therefore be for example personal computers, servers, programmable logic controllers (PLCs), handheld computer systems, pocket PC devices, mobile radios and other communication devices that can process data in computer-aided fashion, processors and other electronic devices for data processing.

Within the context of embodiments of the invention, “computer-aided” can be understood to mean for example an implementation of the method in which in particular a processor carries out at least one method step of the method.

Within the context of embodiments of the invention, a “processor” can be understood to mean for example a machine or an electronic circuit. A processor can be in particular a central processing unit (CPU), a microprocessor or a microcontroller, for example an application-specific integrated circuit or a digital signal processor, possibly in combination with a memory unit for storing program commands, etc. A processor can for example also be an IC (integrated circuit), in particular an FPGA (field programmable gate array) or an ASIC (application-specific integrated circuit), or a DSP (digital signal processor) or a graphics processor GPU (graphics processing unit). A processor can also be understood to mean a virtualized processor, a virtual machine or a soft CPU. It can for example also be a programmable processor that is equipped with configuration steps for carrying out the method according to embodiments of the invention or that is configured by means of configuration steps such that the programmable processor realizes the features according to embodiments of the invention for the method, the component, the modules or other aspects and/or subaspects of embodiments of the invention.

Within the context of embodiments of the invention, a “memory unit” or a “memory module” and the like can be understood to mean for example a volatile memory in the form of random-access memory (RAM) or a permanent memory such as a hard disk or a data medium.

Within the context of embodiments of the invention, a “module” can be understood to mean for example a processor and/or a memory unit for storing program commands. By way of example, the processor is configured specifically to execute the program commands such that the processor performs functions to implement or realize the method according to embodiments of the invention or a step of the method according to embodiments of the invention.

Within the context of embodiments of the invention, “providing” can be understood to mean for example loading or storing, for example the first transaction data record and/or the control action transaction and/or state assertion transaction, on or from a memory module.

Within the context of embodiments of the invention, a “checksum”, for example the first checksum, a second checksum, a node checksum, a transaction checksum or a concatenation checksum, can be understood to mean for example a cryptographic checksum or cryptographic hash or hash value, which are formed or calculated in particular by means of a cryptographic hash function over a data record and/or data and/or one of the transactions and/or a link header. A checksum can be in particular a checksum (checksums) or hash value (hash values) of a hash tree (e.g. Merkle tree, Patricia tree). Furthermore, it can in particular also be understood to mean a digital signature or a cryptographic message authentication code.

Within the context of embodiments of the invention, a “first checksum” can be understood to mean a checksum that is calculated over the data (records) of a transaction, for example. Instead of the data, e.g. the selected portion of the data, a transaction can comprise only the checksum—more precisely the applicable associated first checksum—for these data, for example. The applicable data can for example then be provided in a further transaction of a further link. By way of example, it is alternatively conceivable for these data to be provided by means of a different communication channel. A node can then for example check the integrity/authenticity of the data by means of the first checksum from the blockchain. In addition to the first checksum, for example, there may also be a supplementary data record stored in the transactions, indicating in particular a memory location at which the data can be retrieved. This is advantageous in particular in order to keep a data size of the blockchain as small as possible. Additionally, for example a computation of a transaction checksum can be speeded up, since in that case there are already checksums and they can immediately be used as leaves of a Merkle tree. In this case, it is in particular possible to dispense with forming a separate checksum over the supplementary data record.

Within the context of embodiments of the invention, a “transaction checksum” can be understood to mean a checksum that is formed in particular over the respective transactions of one of the respective links and/or preceding link/precursor link of a link of the blockchain. Additionally, or alternatively, the transaction checksum may in particular also have been formed over transactions of a preceding link/precursor link of the link. The transaction checksum can in particular also be realized in this case by means of a hash tree, for example a Merkle tree [1] or a Patricia tree, wherein the transaction checksum is in particular the root checksum of the Merkle tree or of a Patricia tree or of a binary hash tree. In particular, transactions are safeguarded by means of further checksums from the Merkle tree or Patricia tree, wherein in particular the further checksums are leaves in the Merkle tree or Patricia tree. The transaction checksum can for example safeguard the transactions by virtue of the root checksum being formed from the further checksums. The transaction checksum can in particular be calculated for transactions of a first link of the links. In particular, such a transaction checksum can influence a succeeding link of the first link in order to concatenate this succeeding link to its preceding links (e.g. the first link), for example, and in particular thus to make an integrity of the blockchain checkable.

Within the context of embodiments of the invention, a “concatenation checksum” can be understood to mean a checksum that indicates or references the preceding link of the blockchain for a respective link of the blockchain (in particular frequently referred to as “previous block hash” in technical terminology) [1]. The concatenation checksum used can be for example the transaction checksum of a link. It is for example alternatively possible for a checksum to be formed over a header of the preceding link or over the entire preceding link and to be used as a concatenation checksum. A respective link of the blockchain comprises a respective concatenation checksum that has been calculated for a preceding link of the respective link.

Within the context of embodiments of the invention, “concatenating the/concatenating links of a blockchain” can be understood to mean for example that links each comprise information (e.g. a concatenation checksum) referring to or referencing another link or multiple other links of the blockchain [1].

Within the context of embodiments of the invention, “insertion into the blockchain” and the like can be understood to mean for example that in particular a transaction or the transactions or a link with its transactions are transmitted to one or more nodes of a blockchain. If these transactions are validated successfully (e.g. by the node (nodes)), for example, these transactions are in particular concatenated as a new link (links) to at least one existing link of the blockchain [1]. In particular, the validation of transactions or the inclusion in a link or a block of the blockchain of a valid, validated transaction or the rejection of an invalid transaction can be referred to as performing the transaction. The performance of test transactions processes the latter by means of the blockchain, for example. This can lead in particular to a transaction being contained in the blockchain as a valid, validated transaction, i.e. in particular being contained or referenced in a concatenated block or link of the blockchain. However, it can for example also lead to a transaction being detected as invalid, not valid, during performance, and this transaction in particular not being contained in the blockchain as a valid, validated transaction, i.e. being contained or referenced in a concatenated block or link of the blockchain. In particular, this validation and/or concatenation can be effected by a trusted node (e.g. a mining node or a blockchain platform). In particular, a blockchain platform can be understood in this instance to mean a blockchain as service, as proposed by Microsoft or IBM, in particular. In particular, a trusted node and/or a node can each save a node checksum (e.g. a digital signature) in a link in order in particular to allow identifiability of the originator of the link and/or to allow identifiability of the node that concatenated the applicable link to at least one other link of the blockchain.

Within the context of embodiments of the invention, “transaction” and “transactions” can be understood to mean for example a smart contract, a data structure or a transaction data record that in particular each comprises one of the transactions or multiple transactions. Within the context of embodiments of the invention, “transaction” and “transactions” can for example also be understood to mean the data of a transaction of a link of a blockchain. A transaction data record or a transaction can comprise a program code that realizes a smart contract, in particular. Within the context of embodiments of the invention, a “transaction data record” can for example also be understood to mean a transaction of a link of a blockchain.

Within the context of embodiments of the invention, a “program code” can be understood to mean for example control commands, program commands or control instructions that are stored in a transaction, in particular.

Within the context of embodiments of the invention, a “smart contract” can be understood to mean for example an executable program code. The program code is in particular executable on a virtual machine.

Within the context of embodiments of the invention, “storing transactions” can be understood to mean for example storing data (e.g. the selected portion of the data, etc.) in a transaction or in a transaction data record. By way of example, it is also conceivable for not the data to be stored directly, but rather for only a checksum (e.g. the first checksum) of the applicable data to be stored in the transaction.

Within the context of embodiments of the invention, “proof-of-work verification” can be understood to mean for example solving a computationally intensive task that is to be solved in particular depending on the link content/content of a first transaction data record [1]. A computationally intensive task of this kind is for example also referred to as a cryptographic puzzle

Within the context of embodiments of the invention, “link” can be understood to mean for example a block of a blockchain, which is realized in particular as a data structure and comprises a respective one of the transactions or multiple instances of the transactions. A link can comprise for example details pertaining to the size (data size in bytes) of the link, a link header (block header), a transaction counter and one or more transactions [1]. The link header can comprise for example a version, a concatenation checksum, a transaction checksum, a time stamp, a proof-of-work verification and a nonce (one-time value, random value or counter used for the proof-of-work verification) [1].

Within the context of embodiments of the invention, “nonce” can be understood to mean for example a cryptographic nonce (abbreviation for: “used only once” [2] or “number used once” [3]). In particular, a nonce denotes single numbers or a letter combination that is used a single time in the respective context (e.g. transaction, data transfer).

Within the context of embodiments of the invention, “preceding links of a (first) link of the blockchain” can be understood to mean for example only the link of the blockchain that directly precedes in particular a (first) link. Alternatively, “preceding links of a (first) link of the blockchain” can in particular also be understood to mean all links of the blockchain that precede the first link. As a result, for example the concatenation checksum or the transaction checksum can be formed in particular only over the link (or the transactions thereof) that directly precedes the first link or over all links (or the transactions thereof) that precede the first link.

Within the context of embodiments of the invention, a “blockchain node”, “node”, “node of a blockchain” and the like can be understood to mean for example devices (e.g. field devices), computers, clients or subscribers that perform operations with a blockchain [1]. Such nodes can for example perform transactions of a blockchain or the links thereof or can insert or concatenate new links with new transactions into the blockchain by means of new links. In particular, this validation and/or concatenation can be effected by a trusted node (e.g. a mining node) or exclusively by trusted nodes. A trusted node is for example a node that has additional security measures (e.g. firewalls, access restrictions pertaining to the node or the like) in order to prevent manipulation of the node. Alternatively, or additionally, when a new link is concatenated to the blockchain, a trusted node can store a second checksum (e.g. a digital signature or a certificate) in the new link, for example. It is thus in particular possible to provide a verification indicating that the link was inserted by a specific node or indicates its origin.

Within the context of embodiments of the invention, a “computer” can be understood to mean for example a computer (system), a client, a device or a server that are each arranged outside the blockchain or are not subscribers of the blockchain (that is to say perform no operations with the blockchain or only interrogate the latter, but without performing transactions, inserting links or calculating proof-of-work verifications). Alternatively, a computer can in particular also be understood to mean a node of a blockchain.

The method is advantageous for identifying for example a deviation in a blockchain realization from an expected functionality in the course of operation. As a result, it is in particular possible for a single client or user to check whether a distributed or provided blockchain infrastructure, as expected, works. This is advantageous in particular if the blockchain is supposed to be used for security-critical applications (control of installations for important infrastructure such as e.g. power station installations). In particular, embodiments of the invention check at runtime whether a blockchain is still running/active (that is to say that operation has not been stopped, is interrupted, or the blockchain has “hung”). The blockchain is for example realized in a manner distributed by a multiplicity of distributed nodes. The number thereof is in particular not explicitly known, which means that it is difficult to use conventional methods (e.g. by means of a ping instruction for the network addresses of known nodes) to check whether there are still enough nodes running for correct operation of the blockchain (this can be prescribed e.g. by a security guideline for the blockchain) or whether other nodes of the blockchain are actually still contactable and perform or validate transactions. Furthermore, it is in particular possible to check whether the functionality of the blockchain is modified in an unexpected or inadmissible manner. This is necessary in particular in the case of durable technical systems that use a blockchain for security-critical control tasks, for example.

By way of example, it is possible to test whether the prescribed transaction appears in a link of the blockchain within a prescribed interval of time and/or the prescribed transaction was validated successfully. If for example an unsuccessful attempt is made to insert the prescribed transaction into the blockchain, the prescribed transaction is not comprised by a link of the blockchain. In such a case, for example testing can result in a stipulated value being recorded as a measured value after a prescribed interval of time (e.g. timeout). If for example the preset value now requires e.g. the validation of the prescribed transaction to be performed within a prescribed time window (e.g. 30 seconds), a deviation is found when the preset value is compared with the measured value. This can also be effected, in particular in an analogous manner, if the insertion or concatenation of the link that comprises the prescribed transaction into/to the blockchain requires longer than the prescribed time window (that is to say the preset value).

In a first embodiment of the method, the insertion results in an attempt being made to store the prescribed transaction and/or the prescribed smart contract in a link of the blockchain and to concatenate the link to at least one link of the blockchain.

The method is advantageous for in particular finding out whether the nodes of the blockchain can actually still validate transactions. The storage results in particular in the prescribed transaction and/or the prescribed smart contract being accepted by the link. If the nodes have dropped out, for example, then they can concatenate the link to one of the other links of the blockchain. As a result, in particular testing of the prescribed transaction results in it being found that the transaction does not actually appear in the blockchain (is not comprised by the blockchain).

In a further embodiment, the links of the blockchain are concatenated to one another by means of a cryptographic hash function (H).

In a further embodiment of the method, the method is cyclically repeated or controlled by a trigger.

The method is advantageous for in particular regularly testing the blockchain. By way of example, a five-hour cycle can be chosen for the cyclic repetition. If the method is actuated by a trigger, for example, then this can be performed in particular when a node is booted during its starting phase.

In a further embodiment of the method, fresh testing results in a new prescribed transaction and/or a new prescribed smart contract being generated with a new content and a respective new preset value assigned to the transaction and/or smart contract.

The method is advantageous for in particular varying the content of the tests. The effect achieved by this is in particular that nodes that have been manipulated by unauthorized third parties cannot easily provide a correct measured value.

In a further embodiment of the method, the testing checks whether the blockchain is still active.

In a further embodiment of the method, the testing checks whether and with what time delay the prescribed transaction and/or the prescribed smart contract is contained in a link of the blockchain.

In a further embodiment of the method, the testing is performed by one or more nodes of the blockchain.

The method is advantageous for in particular increasing the reliability of testing, since this allows the blockchain to be tested redundantly by multiple nodes of the blockchain.

In a further embodiment of the method, the prescribed transaction and/or the prescribed smart contract comprises a nonce value.

The method is advantageous for in particular easily varying the content of the prescribed transaction when the blockchain is tested afresh.

In a further embodiment of the method, the measured value and/or the deviation and/or the preset value are inserted into or concatenated to the blockchain as a transaction, wherein this insertion is effected by a node by using the control signal.

According to a further aspect, embodiments of the invention relates to a test generator (e.g. a node) for testing a blockchain, having:
a providing module for providing a prescribed transaction and/or a prescribed smart contract, wherein the prescribed transaction and/or the prescribed smart contract each have an associated preset value;
a memory module for storing the prescribed transaction and/or the prescribed smart contract in the blockchain;
a performance module for performing the prescribed transaction and/or the prescribed smart contract, wherein a measured value for the performance is recorded for the prescribed transaction and/or the prescribed smart contract;
a test module for testing the measured value on the basis of the preset value, wherein a deviation from the preset value results in a control signal being provided.

In a further embodiment of the test generator, the test generator has a transmission module for transmitting the prescribed transaction and/or the prescribed smart contract.

The method is advantageous for in particular transmitting the prescribed transactions to nodes or computers outside the blockchain. The transmitting can be effected for example in connection-oriented fashion (e.g. on a TCP/IP basis), in connectionless fashion (e.g. on a UDP basis) or on a broadcast/multicast basis.

In a further embodiment of the test generator, the test generator comprises at least one further module or multiple further modules for performing the method according to embodiments of the invention (or one of the embodiments of the method) for computer-aided testing of the blockchain.

In addition, a computer program product (non-transitory computer readable storage medium having instructions, which when executed by a processor, perform actions) having program commands for performing the methods according to embodiments of the invention is claimed, wherein one of the methods according to embodiments of the invention, all the methods according to embodiments of the invention or a combination of the methods according to embodiments of the invention are respectively performable by means of the computer program product.

Additionally, a variant of the computer program product having program commands for configuring a creating device, for example a 3D printer, a computer system or a production machine suitable for creating processors and/or devices, is claimed, wherein the creating device is configured with the program commands such that the test generator according to embodiments of the invention is created. Furthermore, a providing apparatus for storing and/or providing the computer program product is claimed. The providing apparatus is for example a data medium that stores and/or provides the computer program product. Alternatively and/or additionally, the providing apparatus is for example a network service, a computer system, a server system, in particular a distributed computer system, a cloud-based computer system and/or a virtual computer system that stores and/or provides the computer program product in the form of a data stream.

This providing takes place for example as a download in the form of a program data block and/or command data block, as a file, in particular as a download file, or as a data stream, in particular as a download data stream, of the complete computer program product. However, this providing can for example also take place as a partial download consisting of multiple parts and in particular downloaded via a peer-to-peer network or provided as a data stream. Such a computer program product is read into a system for example by using the providing apparatus in the form of the data medium and executes the program commands, so that the method according to embodiments of the invention is executed on a computer or configures the creating device such that it creates the test generator according to embodiments of the invention.

### BRIEF DESCRIPTION

Some of the embodiments will be described in detail, with references to the following Figures, wherein like designations denote like members, wherein:

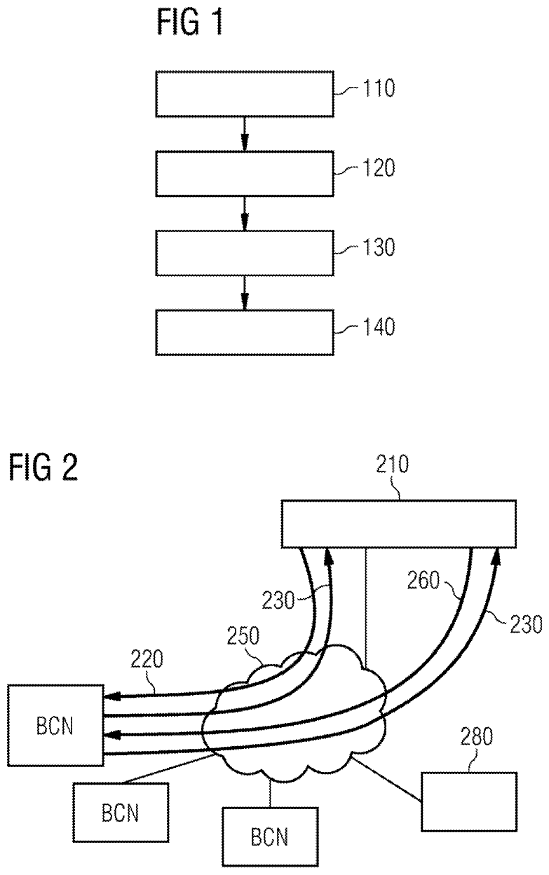

FIG. 1 shows a first exemplary embodiment of the invention as a flowchart;

FIG. 2 shows a second exemplary embodiment of the invention;

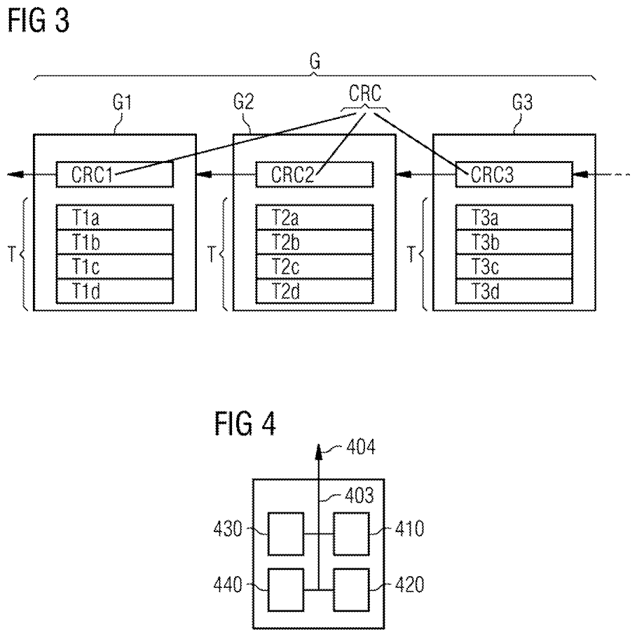

FIG. 3 shows a third exemplary embodiment of the invention; and

FIG. 4 shows a fourth exemplary embodiment of the invention as a test generator.

### DETAILED DESCRIPTION

The exemplary embodiments that follow, unless indicated otherwise or already indicated, comprise at least one processor and/or a memory unit in order to implement or carry out the method.

Moreover, in particular a (relevant) person skilled in the art, with knowledge of the method claim/method claims, is of course aware of all routine possibilities for realizing products or possibilities for implementation in the prior art, and so there is no need in particular for independent disclosure in the description. In particular, these customary realization variants known to the person skilled in the art can be realized exclusively by hardware (components) or exclusively by software (components). Alternatively and/or additionally, the person skilled in the art, within the scope of his/her expert ability, can choose to the greatest possible extent arbitrary combinations according to embodiments of the invention for hardware (components) and software (components) in order to implement realization variants according to embodiments of the invention.

A combination according to embodiments of the invention for hardware (components) and software (components) can occur in particular if one portion of the effects according to embodiments of the invention is brought about exclusively by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of embodiments of the invention to name all these realization possibilities. In this respect, in particular all the exemplary embodiments below are intended to demonstrate merely by way of example a few ways in which in particular such realizations of the teaching according to embodiments of the invention could be manifested.

Consequently, in particular the features of the individual exemplary embodiments are not restricted to the respective exemplary embodiment, but rather relate in particular to embodiments of the invention in general. Accordingly, features of one exemplary embodiment can also serve as features for another exemplary embodiment, in particular without this having to be explicitly stated in the respective exemplary embodiment.

FIG. 1 shows a first exemplary embodiment of the invention as a flowchart for the method according to embodiments of the invention for computer-aided testing of a blockchain.

The method comprises a first method step 110 for generating a prescribed transaction and/or a prescribed smart contract, wherein the prescribed transaction and/or the prescribed smart contract each have an associated preset value. The prescribed transaction can comprise a cryptographic nonce that is used as a parameter for a cryptographic function and delivers a reproducible result (even when the cryptographic function is used multiple times) for this nonce. This reproducible result can then be used as the preset value, for example. The preset value can furthermore also contain further data, such as for example a time window within which the prescribed transaction needs to be concatenated to the blockchain. The preset value can also comprise a further time window indicating how long at most a validation or performance of the prescribed transaction is permitted to last.

The method comprises a second method step for inserting 120 the prescribed transaction and/or the prescribed smart contract into the blockchain. For this purpose, the prescribed transaction can be transmitted to nodes of the blockchain that are supposed to validate the prescribed transactions.

The method comprises a third method step for performing 130 the prescribed transaction and/or the prescribed smart contract, wherein a measured value for the performance of the prescribed transaction and/or the prescribed smart contract is recorded. At this juncture, the method now waits for the prescribed transaction to be comprised in a link of the blockchain. If the prescribed transaction is not contained in a link of the blockchain e.g. after a prescribed time window, then the measured value recorded is a timeout, for example.

The method comprises a fourth method step for testing 140 the measured value on the basis of the preset value, wherein a deviation from the preset value and/or a concordance with the preset value results (result) in a control signal being provided. To this end, the preset value can be compared with the measured value, for example. The preset value can for example prescribe threshold values (e.g. a period of time before a transaction is contained in successfully validated fashion in the blockchain, a number of successfully validated transactions contained in the blockchain) that the measured value must not exceed or is supposed to contain.

If the preset value requires the prescribed transaction to be contained in a link of the blockchain within 30 seconds, for example, and the measured value contains a timeout, then a deviation from the preset value is found. If the measured value contains e.g. 20 seconds, on the other hand, then a concordance with the preset value is found.

The result (that is to say the concordance or the deviation) can then be provided by the control signal. The control signal can comprise the measured value, the preset value, the result or a combination of these data.

In other words, a method is realized in which the test vector is provided in the form of a prescribed transaction (e.g. a valid transaction and invalid transaction) and/or a prescribed smart contract for the blockchain.

It is furthermore checked whether the prescribed transaction/smart contract is concordant with its respective preset value. This may be e.g. positive tests in the form of a valid transaction that are then contained in the blockchain as a validated transaction. This may be e.g. negative tests in the form of an invalid transaction that must not be contained in the blockchain as a valid/successfully validated transaction.

The method or the test is regularly repeated. When the method is repeated, a repetition can result in particular in new prescribed transactions (or a multiplicity of prescribed transactions) being put into the blockchain, and these each being assigned a preset value.

The method can be realized by one or more nodes, for example. A node can for example insert the prescribed transaction into the blockchain, attempt to concatenate it and test it when the node is activated (e.g. a powerup test when a node is booted) and/or repeatedly in the course of operation of the node.

Similarly, it is possible for in particular a smart contract to generate, insert, perform and test the prescribed transaction. Alternatively, a first smart contract can produce and insert the prescribed transaction while a second smart contract performs and tests the prescribed transaction.

In other words, this realizes a built-in self-test for a blockchain. The result of the testing can be provided to the blockchain as a transaction (e.g. in the same blockchain or in a second blockchain).

Furthermore, the liveliness (e.g. testing whether enough nodes of the blockchain are still active/contactable) of the blockchain can be checked by virtue of the prescribed transaction (e.g. in the form of a liveliness test transaction) that comprises a nonce being introduced into the blockchain, and it being checked/tested whether and when (after what period of time) this prescribed transaction is confirmed in the blockchain or is present as successfully validated (it is e.g. confirmed when it is contained in a link of the blockchain).

The check/testing can be effected for example by a node that puts a liveliness test transaction into the blockchain and checks whether and with what delay this transaction is confirmed.

The check/testing can be realized for example also by a node that puts in the liveliness test transaction and checks the presence thereof

It is for example likewise possible for a first node to put in liveliness test transactions that check/test one or more other nodes. This is advantageous in particular in that when there are a multiplicity of nodes it is not necessary for each node to check the liveliness of the blockchain separately.

In a further variant, the test of the liveliness of the blockchain or of the nodes thereof is realized by a smart contract. To this end, the smart contract generates the prescribed transaction (e.g. the liveliness test transaction), inserts it into the blockchain, performs the prescribed transaction and tests the measured value against the preset value.

In a further variant, there is provision for separate smart contracts in order to generate, insert, perform and test liveliness test transactions. To this end, it is possible for example for a nonce (e.g. a random number or a message authentication code, generated by means of a cryptographic key, or a digital signature or a hash value) to be generated and put into the blockchain as a prescribed transaction in the form of a liveliness check transaction.

It is checked/tested whether and on the basis of what recorded measured value e.g. the delay occurs before this transaction is confirmed in the blockchain. This then results in a test being performed to determine whether the measured value keeps to the associated preset value, e.g. the preset value prescribes a maximum admissible delay within which the transaction is supposed to be confirmed. In one variant, a result of this test can likewise be put into the blockchain (or into a second blockchain) as a liveliness attestation transaction.

The control signal can be used in different ways: if the control signal indicates a malfunction in the blockchain, then for example an audible or visual alarm notification can be provided, an electrical switching signal can be provided, or an error message can be recorded in an error memory. Furthermore, it is possible to block a data transfer, e.g. at a network boundary, by means of a firewall, or to put a control system into a failsafe operating state.

FIG. 2 shows a second exemplary embodiment of the invention, which is realized by a system.

Specifically, FIG. 2 shows an exemplary system having multiple (blockchain) nodes BCN that realize a blockchain (e.g. Bitcoin nodes or Ethereum nodes) and are connected to one another by means of a network 250 (e.g. a LAN, WAN or the Internet).

In this example, there is provision for a test generator 210 (a special node or service) (the test generator likewise being connected to the network 250) that attempts to put a prescribed transaction (transactions) 220 (as has been explained in FIG. 1, for example) into the blockchain. These can be valid transactions (positive tests) and invalid transactions (negative tests). The test generator 210 checks whether and which of the prescribed transactions are confirmed 230 in the blockchain, i.e. are contained in a confirmed link of the blockchain. A check is performed to determine whether the prescribed transactions with positive tests are contained in the blockchain, and that no prescribed transactions with negative tests are contained in the blockchain. The result of the test is likewise confirmed as a transaction (e.g. result transaction 260) of the blockchain in this example.

As a result, the nodes BCN themselves or other devices 280 (e.g. relying devices, firewalls, gateways) can check the result without themselves needing to repeat the test.

FIG. 3 shows a third exemplary embodiment of the invention, which is a blockchain suitable for realizing the preceding exemplary embodiments.

Specifically, FIG. 3 shows the links G, for example a first link G1, a second link G2 and a third link G3, of a blockchain.

The links G each comprise multiple transactions T. The first link G1 comprises a first transaction T1a, a second transaction T1b, a third transaction T1c and a fourth transaction T1d, for example. The second link G2 comprises a fifth transaction T2a, a sixth transaction T2b, a seventh transaction T2c and an eighth transaction T2d, for example. The third link G3 comprises a ninth transaction T3a, a tenth transaction T3b, an eleventh transaction T3c and a twelfth transaction T3d, for example.

The links G each additionally also comprise a concatenation checksum CRC that is formed on the basis of the direct precursor link. Therefore, the first link G1 comprises a first concatenation checksum CRC1 from its precursor link, the second link G2 comprises a second concatenation checksum CRC2 from the first link G1, and the third link G3 comprises a third concatenation checksum CRC3 from the second link G2. The concatenation checksum is formed by means of the link header of the applicable precursor link. The concatenation checksums CRC can be formed by using a cryptographic hash function such as e.g. SHA-256, KECCAK-256 or SHA-3.

Additionally, each of the links can comprise a transaction checksum. The transaction checksum can be realized by means of a hash tree.

In order to form the hash tree, a third checksum (generally likewise a hash value formed on the basis of the transactions/transaction data records) is formed for each transaction of a link. Usually, a hash tree, e.g. a Merkle tree or Patricia tree, is used, the root hash value/root checksum of which is saved in the respective link as a transaction checksum.

In one variant, the transaction checksum is used as concatenation checksum.

A link can furthermore have a time stamp, a digital signature and a proof-of-work verification, as explained in the embodiments of the invention.

If the blockchain depicted in FIG. 3 now realizes the method according to embodiments of the invention from FIG. 1 and/or FIG. 2, prescribed transactions (e.g. transactions with positive tests and negative tests) are attempted to be inserted into the blockchain. As such, for example the positive tests can be concatenated to the blockchain as the first transaction T1a, the second transaction T1b and the third transaction T1c by means of the first link G1 as successfully validated transactions. Additionally, general transactions (e.g. transactions pertaining to payment processes) may be contained in the blockchain. The preset value now prescribes that the blockchain is permitted to contain only these positive tests or a number of positive tests or the transactions thereof, for example. If for example an attempt was made to insert a prescribed transaction with a negative test into the blockchain and were this negative test contained in a transaction T of a link G of the blockchain, there would be an error, or a deviation from the preset value would be found.

Furthermore, the result of the test is likewise provided in the form of a successfully validated transaction, for example the ninth transaction T3a.

FIG. 4 shows a fourth exemplary embodiment of the invention as a test generator for computer-aided testing of a blockchain. The apparatus can be the test generator from FIG. 2, for example.

The apparatus comprises a generation module 410, an insertion module 420, a performance module 430, a test module 440 and an optional first communication interface 404 (e.g. for connection to the network from FIG. 2), which are communicatively connected to one another by means of a first bus 403.

The apparatus can for example additionally also comprise a further or multiple further component (components), such as for example a processor, a memory unit, an input device, in particular a computer keyboard or a computer mouse, and a display device (e.g. a monitor). The processor can for example comprise multiple further processors, wherein the further processors each realize one or more of the modules, for example. Alternatively, the processor realizes all modules of the exemplary embodiment, in particular. The further component (components) may for example likewise be communicatively connected to one another by means of the first bus 403.

The processor can be an ASIC, for example, which has been realized on an application-specific basis for the functions of a respective module or all modules of the exemplary embodiment (and/or of further exemplary embodiments), the program component and the program commands being realized as integrated circuits, in particular. The processor can for example also be an FPGA that is configured in particular by means of the program commands such that the FPGA realizes the functions of a respective module or of all modules of the exemplary embodiment (and/or of further exemplary embodiments).

The generation module 410 is configured to generate a prescribed transaction and/or a prescribed smart contract, wherein the prescribed transaction and/or the prescribed smart contract each have an associated preset value.

The generation module 410 can be implemented or realized by means of the processor, the memory unit and a first program component, for example, wherein for example executing program commands of the first program component configures the processor, or the program commands mean that the processor is configured, such that the prescribed transaction and/or the prescribed smart contract is generated.

The insertion module 420 is configured to insert the prescribed transaction and/or the prescribed smart contract into the blockchain.

The insertion module 420 can be implemented or realized by means of the processor, the memory unit and a second program component, for example, wherein for example executing program commands of the second program component configures the processor, or the program commands mean that the processor is configured, such that the prescribed transaction and/or the prescribed smart contract is inserted.

The performance module 430 is configured to perform the prescribed transaction and/or the prescribed smart contract, wherein a measured value for the performance is recorded for the prescribed transaction and/or the prescribed smart contract.

The performance module 430 can be implemented or realized by means of the processor, the memory unit and a third program component, for example, wherein for example executing program commands of the third program component configures the processor, or the program commands mean that the processor is configured, such that the prescribed transaction and/or the prescribed smart contract is performed.

The test module 440 is configured to test the measured value on the basis of the preset value, wherein a deviation from the preset value results in a control signal being provided.

The test module 440 can be implemented or realized by means of the processor, the memory unit and a fourth program component, for example, wherein for example executing program commands of the fourth program component configures the processor, or the program commands mean that the processor is configured, such that the measured value is tested.

The execution of the program commands of the respective modules can be effected in this case for example by means of the processor itself and/or by means of an initialization component, for example a loader, or a configuration component.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for computer-aided testing of a blockchain, having the following method steps:
generating at least one of a prescribed transaction and a prescribed smart contract, wherein the prescribed transaction and/or the prescribed smart contract each have an associated preset value;
inserting the at least one of the prescribed transaction and the prescribed smart contract into the blockchain;
performing the prescribed transaction and/or the prescribed smart contract, wherein a measured value for the performance of the at least one of the prescribed transaction and the prescribed smart contract is recorded, wherein the performance of the prescribed transaction and the prescribed smart contract causes the processing of the at least one of the prescribed transaction ands of the prescribed smart contract by the blockchain;
testing the measured value on the basis of the preset value, wherein a deviation from the preset value results in a control signal being provided.

2. The method as claimed in claim 1, wherein the insertion results in an attempt being made to store the at least one of prescribed transaction and the prescribed smart contract in a link of the blockchain and to concatenate the link to at least one link of the blockchain.

3. The method as claimed in claim 1, wherein links of the blockchain are concatenated to one another by means of a cryptographic hash function.

4. The method as claimed in claim 1, wherein the method is cyclically repeated or controlled by a trigger.

5. The method as claimed in claim 1, wherein fresh testing results in at least one of a new prescribed transaction and a new prescribed smart contract being generated with a new content and a respective at least one of a new preset value assigned to the transaction and smart contract.

6. The method as claimed in claim 1, wherein the testing checks whether the blockchain is still active.

7. The method as claimed in claim 1, wherein the testing checks whether and with what time delay the at least one of the prescribed transaction and the prescribed smart contract is contained in a link of the blockchain.

8. The method as claimed in claim 1, wherein the testing is performed by one or more nodes of the blockchain.

9. The method as claimed in claim 1, wherein the at least one of the prescribed transaction and/or the prescribed smart contract comprise a nonce value.

10. The method as claimed in claim 1, wherein the at least one of the measured value, the deviation and the preset value are inserted or concatenated into the blockchain as a transaction, wherein this insertion is effected by a node by using the control signal.

11. A test generator for testing a blockchain, having:
a generation module for generating at least one of a prescribed transaction and a prescribed smart contract, wherein the at least one of a prescribed transaction and the prescribed smart contract each have an associated preset value;
an insertion module for inserting the at least one of the prescribed transaction and the prescribed smart contract into the blockchain;
a performance module for performing the at least one of the prescribed transaction and the prescribed smart contract, wherein a measured value for the performance is recorded for the at least one of the prescribed transaction and the prescribed smart contract, wherein the performance of the at least one of the prescribed transaction and of of the prescribed smart contract causes the processing of the at least one of the prescribed transaction and of the prescribed smart contract by the blockchain;
a test module for testing the measured value on the basis of the preset value, wherein a deviation from the preset value results in a control signal being provided.

12. The test generator as claimed in claim 11, wherein the test generator has a transmission module for transmitting the prescribed transaction and or the prescribed smart contract.

13. A computer program product, comprising a computer readable hardware storage device having computer readable program code stored therein, said program code executable by a processor of a computer system to implement a method having program commands for performing the methods as claimed in claim 1.

14. A computer program product having program commands for a creating device configured by the program commands to create the test generator as claimed in claim 11.

15. A providing apparatus for the computer program product as claimed in claim 13, wherein the providing apparatus at least one of stores and provides the computer program product.
